(19) United States
(12) Patent Application Publication
(10) Pub. No.: US 2014/0200797 A1
(43) Pub. Date: Jul. 17, 2014

(54) Eco-friendly intelligent traffic detection system

(71) Applicant: Song Ye, Nanjing (CN)

(72) Inventor: Song Ye, Nanjing (CN)

(21) Appl. No.: 13/889,853

(22) Filed: May 8, 2013

(30) Foreign Application Priority Data
Jan. 15, 2013 (CN) 201310014614.0

(51) Int. Cl. G08G 1/01

(52) U.S. Cl. CPC G08G 1/012
USPC 701/119

(57) ABSTRACT

An eco-friendly intelligent traffic detection system is provided, the traffic detection system is based on wireless network architecture. The system is linked to a navigation network, and reminds drivers of road conditions, the system can also be linked to mobile base station, in order to achieve a purpose of rational planning, a government department of transportation can manage and analyze the road conditions by uploading data. A purpose of the present invention is realized by: locating a vehicle by a built-in navigation system and a GIS system; recording average vehicle speeds and calculating effective speeds of the mobile devices within a certain range; the present invention has advantages of low cost, environment protection, etc.

### FIELD OF INVENTION

The present invention relates to an eco-friendly intelligent traffic detection system, and more particularly to a traffic detection system based on a cellular data network and a satellite navigation system.

The system is based on the conventional cellular data network and extra devices are not needed. By detecting vehicle flow rate through a GPS/RNSS navigation system and the cellular data network, an optimized choice of routes for vehicles is provided for improving road traffic efficiency, relieving traffic congestion and decreasing pollutant emissions.

### DESCRIPTION OF RELATED ARTS

With more and more urban vehicles, traffic congestion is getting more and more serious, and city traffic detection system plays an important role in uninterrupted traffic of vehicles. At the meantime, Chinese government has made a strategic requirement of energy saving and environmental protection, technologies from communication and information fields are actively applied for the development of eco-friendly intelligent traffic detection systems and the improvement of management and efficiency of Chinese transportation systems.

At present, a conventional traffic detection system is realized by radio frequency identification RFID technology, camera shooting technology, etc., but the detection system is only adaptable in an environment with related hardwares, if all the city arterial streets were covered, a huge amount of hardwares and money for hardwares would be needed. Therefore, for developing a low cost eco-friendly intelligent traffic detection system, an invention of a traffic detection system based on the fusion of a GPS/RNSS navigation system and a cellular data network has an important practical significance.

### SUMMARY OF THE PRESENT INVENTION

An object of the present invention is to provide an eco-friendly design method of a traffic detection system, so as to lead to an eco-friendly intelligent traffic detection system, the system detects vehicle speeds and flow rates with a help of a navigation system and a cellular data system, and the system has an extensive practical significance of no extra hardware needed, low cost and high environmental protection. In order to accomplish the above objects, the present invention provides:

an eco-friendly intelligent traffic detection system, comprising a mobile device with navigation capability, a navigation system and a public mobile communication network; wherein a method of the traffic detection system comprises steps of:

a) taking the mobile device of a driver or a passenger in a vehicle running on a road as a vehicle speed sensor by combining a position distribute of the mobile device with a road traffic map through a navigation system, wherein a speed of the vehicle is obtained according to an change of a position of the mobile device and a related time;

wherein the traffic detection system utilizes the road traffic map to identify precise latitude and longitude for distinguishing locations of city motorways and cycleways (i.e., map data processing), roads are classified according to the road traffic map, meanwhile, a range of the location data of the mobile devices are defined according to boundary data of each road;

the traffic detection system distinguishes the roads by utilizing Grid as road marks (wherein the Grid is a road map grid based on GPS), the Grid has a characteristic of uniqueness, when being processed, the roads should be divided into straight and flat parts and the road marks should be latitude and longitude marks for identifying ranges of the motorways and obtaining resource ranges of the location of the mobile devices;

b) identifying location information of the mobile devices by the navigation system for identifying the location of arterial motorways;

wherein the traffic detection system takes advantage of base stations of a public mobile communication network, and navigation modules related to the navigation system are installed on the base stations, location information of the vehicles is obtained through the base stations and speed information of the mobile devices on the motorways is obtained through the mobile communication network;

the location and the speed information of the vehicles near the base stations is obtained through the navigation modules; then the location information of the vehicles is compared with map information in coordinate; and range information of the cycleways is ignored and the speed information of the vehicles on the motorways is drawn out for obtaining effective speed information of the vehicles.

Additionally, a display of the vehicle flow rate is based on maps (such as road traffic maps).

The navigation system is a GPS system, a RNSS system or other satellite navigation system.

In step a), the mobile device within a base range is located by the base, and a moving distance lₜ of the mobile device in a time t is detected, a moving distance l_{t+Δt} is detected again after a time Δt, therefore, an effective speed V̅ᵢ̅ of the mobile device is obtained, and the effective speed V̅ᵢ̅ of the mobile device is the effective speed V̅ᵢ̅ of the vehicle;

supposing that a total detecting time is T=n×t, wherein n is times of detecting, an average effective speed of the vehicle is obtained in the total detecting time T, a speed average value V̅ₙ̅ is obtained by arithmetic method, V̅ₙ̅=1/nΣ_{iε[l,n]} V̅ᵢ̅;

in step b), by obtaining the effective speed V̅ᵢ̅ of the corresponding vehicle, an average effective speed of all vehicles detected is obtained, therefore, an effective speed V̅_̅{̅t̅o̅t̅a̅ l̅n̅}̅ of the vehicle flow on the arterial motorways is obtained;

a method for obtaining V̅_̅{̅t̅o̅t̅a̅ l̅n̅}̅ is that, supposing that a number of mobile devices is N, each of the mobile devices has the average speed V̅ₙ̅ thereof, the effective speed V̅_̅{̅t̅o̅t̅a̅ l̅n̅}̅ of the vehicle flow on the motorways is obtained by arithmetic method, V̅_̅{̅t̅o̅t̅a̅ l̅n̅}̅=1/nΣ_{iε[l,N]} V̅ₙ̅, the effective speed of the vehicle flow is compared with a speed limitation V_{lim it} of the arterial motorway for obtaining information of the vehicle flow rate on the arterial motorway.

Therefore, the present invention has advantages as follows: environment protection, no extra hardware needed and capability of wide range detecting of vehicle flow rate. With the help of GPS/RNSS and cellular network, the moving vehicles on the motorways are detected precisely, at the meantime, the information of the vehicle flow rate is obtained, the information of the vehicle flow rate on the arterial motorway is stored in internal memory, statistical traffic information is sent to a remote information center. The present invention is adaptable to a further development of domestic networks and business transactions.

These and other objectives, features, and advantages of the present invention will become apparent from the following detailed description, the accompanying drawings, and the appended claims.

### BRIEF DESCRIPTION OF THE DRAWINGS

FIG. 1 is a sketch view of a vehicle management system based on a GPS/RNSS navigation system and base station networks according to a preferred embodiment of the present invention.

FIG. 2 is a flowchart of the system according to the preferred embodiment of the present invention.

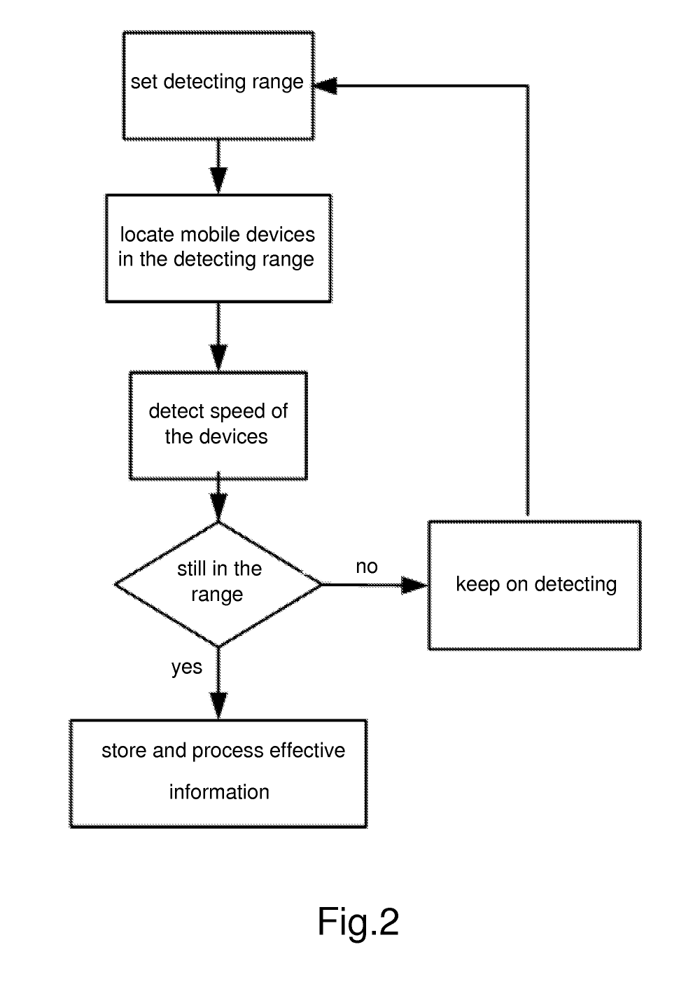

### DETAILED DESCRIPTION OF THE PREFERRED EMBODIMENT

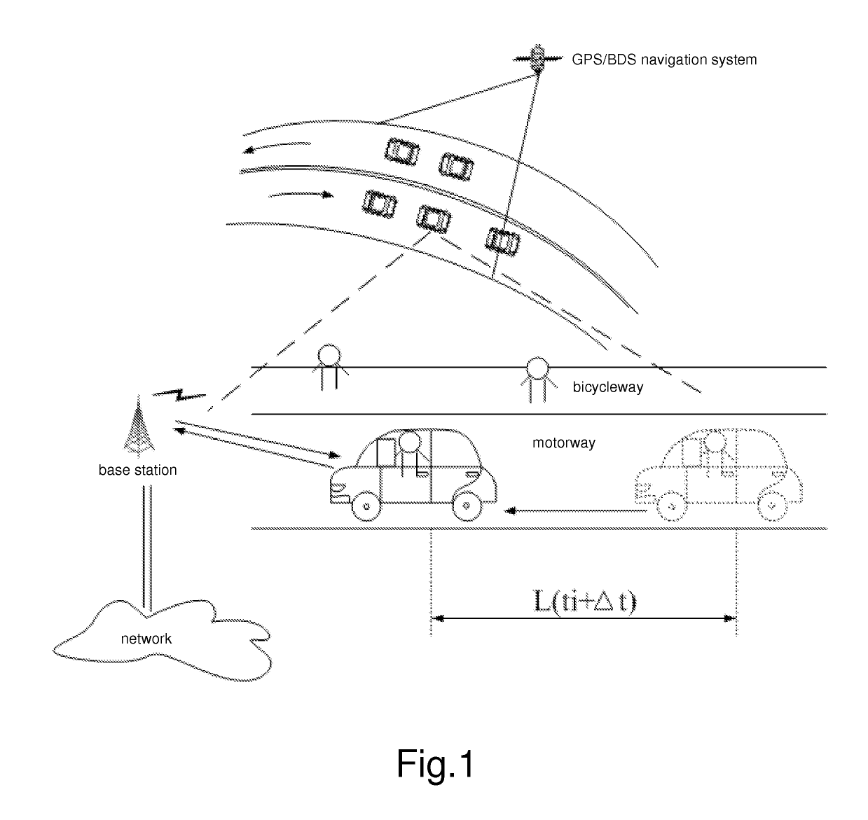

Referring to FIG. 1 of the drawings, according to a preferred embodiment of the present invention is illustrated, wherein:

a method of the system comprising steps of:

a) taking the mobile device of a driver or a passenger in a vehicle running on a road as a vehicle speed sensor by combining a position distribute of the mobile device with a road traffic map through a navigation system, wherein a speed of the vehicle is obtained according to an change of a position of the mobile device and a related time;

b) identifying locations of arterial motorways by a GPS/RNSS navigation system, and combining a cellular data network such as GPRS and a vehicle locating network for locating the arterial motorways;

the mobile device in a locking range is detected by a base station for detecting a moving distance lₜ in a time t, an effective speed V̅ᵢ̅ of the mobile device is obtained, a total detecting time is T=n×t.

By obtaining the effective speed V̅ᵢ̅ of the vehicle, an average effective speed of all vehicles detected is obtained, an effective speed V̅_̅{̅t̅o̅t̅a̅ l̅n̅}̅ of the vehicle flow on the arterial motorways is obtained, the effective speed of the vehicle flow is compared with a speed limitation V_{lim it} of the arterial motorway, and information of the vehicle flow rate on the arterial motorways is obtained, the information is capable of showing conditions of the vehicle flow rate well.

The mobile devices send data to the cellular network by utilizing uplink channels, the base station obtains the speed information, the more the vehicles there are, the more the mobile devices there are, and the more accurate the data is. Thus, a vehicle flow rate detection system under conventional network system architecture is realized.

The present invention takes advantage of conventional mature technologies for realizing a new traffic detection system under guidance of the present invention, the traffic detection system has advantages of:

1. no extra hardware such as RFID radio frequency identification device or camera needed, wherein the traffic detection system is eco-friendly.

2. detecting the vehicles on the arterial motorways and deciding calculating target efficiently by combining the GPS/RNSS satellite navigation system with the traffic map.

3. detecting the vehicle speed in a certain range for obtaining vehicle flow rate data.

4. three status for vehicle flow rate judgment: normal and clear, full load, and overload.

5. measured data are uploaded to the base station for being processed and calculated, data are obtained by government or mobile companies for ensuring clear traffic for the vehicle flow.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An eco-friendly intelligent traffic detection system, wherein said eco-friendly intelligent traffic detection system comprises a mobile device with navigation capability, a navigation system and a public mobile communication network; a method for operating said system comprising steps of:
a) taking the mobile device of a driver or a passenger in a vehicle running on a road as a vehicle speed sensor by combining a position distribute of the mobile device with a road traffic map through a navigation system, wherein a speed of the vehicle is obtained according to an change of a position of the mobile device and a related time;
wherein the traffic detection system utilizes the road traffic map to identify precise latitude and longitude for distinguishing locations of city motorways and cycleways, roads are divided according to the road traffic map, meanwhile, a range of the location data of the mobile devices are defined according to boundary data of each road;
b) obtaining location information of the mobile devices by the navigation system for identifying the location of arterial motorways;
wherein the traffic detection system takes advantage of base stations of a public mobile communication network and navigation modules related to the navigation system are installed on the base stations, location information of the vehicles is obtained through the base stations and speed information of the mobile devices on the motorways is obtained through the mobile communication network;
the location and the speed information of the vehicles near the base stations is obtained through the navigation modules; then the location information of the vehicles is compared with map information in coordinate; and range information of the cycleways is ignored and the speed information of the vehicles on the motorways is drawn out for obtaining effective speed information of the vehicles.

2. The eco-friendly intelligent traffic detection system, as recited in claim 1, wherein said navigation system is a GPS system or a RNSS system.

3. The eco-friendly intelligent traffic detection system, as recited in claim 1, wherein
in step a), the mobile device in a base range is located by the base, and a moving distance lₜ of the mobile device in a time t is detected, a moving distance l_{t+Δt} is detected again after a time Δt, therefore, an effective speed V̅ᵢ̅ of the mobile device is obtained, and the effective speed V̅ᵢ̅ of the mobile device is the effective speed V̅ᵢ̅ of the vehicle;
supposing that a total detecting time is T=n×t, wherein n is times of detecting, an average effective speed of the vehicle is obtained in the total detecting time T, a speed average value V̅ₙ̅ is obtained by arithmetic method, V̅ₙ̅=1/nΣ_{iε[l,n]} V̅ᵢ̅;
in step b), by obtaining the effective speed V̅ᵢ̅ of the corresponding vehicle, an average effective speed of all vehicles detected is obtained, therefore, an effective speed V̅_̅{̅t̅o̅t̅a̅ l̅n̅}̅ of the vehicle flow on the arterial motorways is obtained;
a method for obtaining V̅_̅{̅t̅o̅t̅a̅ l̅n̅}̅ is that, supposing that a number of mobile devices is N, each of the mobile devices has the average speed V̅ₙ̅ thereof, the effective speed V̅_̅{̅t̅o̅t̅a̅ l̅n̅}̅ of the vehicle flow on the motorways is obtained by arithmetic method, V̅_̅{̅t̅o̅t̅a̅ l̅n̅}̅=1/NΣ_{iε[l,N]} V̅ₙ̅, the effective speed of the vehicle flow is compared with a speed limitation Vₗᵢₘᵢₜ of the arterial motorway for obtaining information of the vehicle flow rate on the arterial motorway.
